(19) United States
(12) Patent Application Publication
(10) Pub. No.: US 2012/0166264 A1
(43) Pub. Date: Jun. 28, 2012

(54) SYSTEMS AND METHODS PROVIDING CUSTOMER REWARDS PROGRAMS

(75) Inventors: Douglas Shum, Lincoln, NE (US); Jonathan Nordhausen, Hickman, NE (US); Cynthe Bailey, Lincoln, NE (US); Brett Erlandson, Lincoln, NE (US); Jeremy Wieser, Omaha, NE (US)

(73) Assignee: FISERV, INC., Brookfield, WI (US)

(21) Appl. No.: 12/977,557

(22) Filed: Dec. 23, 2010

(51) Int. Cl. G06Q 30/00

(52) U.S. Cl. 705/14.17

(57) ABSTRACT

Systems and methods can provide customer rewards programs. Example embodiments can include a rewards program that includes: identifying a rewards program associated with a financial institution to reward a customer of the financial institution; and identifying at least one rewards rule associated with the rewards program that indicates at least one reward to be provided if multiple criteria are satisfied. Upon determining that the criteria are satisfied, a transaction can be generated to provide a reward for the customer.

### FIELD OF THE INVENTION

Aspects of the invention relate generally to financial institution customer activity analysis, and more particularly, to systems and methods providing customer rewards programs.

### BACKGROUND OF THE INVENTION

Customer loyalty programs are continuing to increase in popularity in many industries. Typical customer loyalty programs provide incentives for customers to continue to do business with the entity offering the incentive. Incentives are provided in a wide variety of forms. Many popular incentive programs provide points or other credits having value that can be utilized at the merchant providing the points. To-date, financial institution customer loyalty programs have generally followed the simplistic models of merchant loyalty programs.

### BRIEF DESCRIPTION OF THE DRAWINGS

Reference will now be made to the accompanying drawings, which are not necessarily drawn to scale, and wherein:

FIG. 1 illustrates a block diagram of an example system that supports one or more relationship rewards processes, according to an example embodiment.

FIG. 2 illustrates a flow diagram of an example method for providing a rewards program, according to an example embodiment of the invention.

FIG. 3 illustrates a flow diagram of an example method for determining rewards rules and criteria for a rewards program, according to an example embodiment of the invention.

FIG. 4 illustrates a flow diagram of an example method for analyzing whether rewards program criteria are satisfied, according to an example embodiment of the invention.

FIG. 5 illustrates a flow diagram of an example method for configuring a rewards program, according to an example embodiment of the invention.

### DETAILED DESCRIPTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may provide systems and methods that facilitate providing customer rewards programs. Generally, customer rewards programs can include analyzing customers' activities with a sponsoring financial institution. Each rewards program may be configured based on a particular rule set that identifies the type of reward (or rewards) to be provided upon meeting a predetermined set of criteria. The criteria may represent or otherwise capture activities that the financial institution values or wishes to encourage its customers to continue to practice. The rewards programs provided by the example embodiments described herein allow for generating and issuing rewards based on more complex customer interactions than conventional rewards systems that typically issue rewards for a merchant based on activities with that merchant or based on transactions using accounts sponsored by that merchant (e.g., frequent flyer programs, loyalty membership points, etc.). Various example embodiments described herein allow identifying and capturing customer activities that are not simply tied to a single account or a single type of transaction. For example, according to one embodiment, one or more rewards may be generated based on the satisfaction of criteria based on information derived from at least two different accounts. The accounts may be financial accounts with the sponsoring financial institution, or they may be accounts that are associated with a product or service offered by the financial institution. In some embodiments, at least one of the accounts may be an external account not related to, or otherwise affiliated with, the sponsoring financial institution. Accordingly, by these systems and methods, financial institutions can reward their customers for more involved interactions and uses of the financial institution, including customers' use of multiple accounts or different services or products provided by the financial institution or for meeting or exceeding threshold levels of activity with the financial institution.

A few example criteria analyzed to generate customer rewards may include, but are not limited to, activities associated with one or more accounts with the financial institution, activities associated with third-party accounts, enrolling and/or use of programs, products, or services offered by the financial institution, purchase or use of products offered by the financial institution, purchase or use of third-party products, threshold levels of activities (e.g., minimum balances, minimum number of purchases, minimum number of transactions, etc.), threshold numbers of services or accounts utilized, customer demographic information, customer analytics data, other customer specific information, or predictive data (e.g., credit ratings, customer forecasting, perceived customer value, etc.). The rewards program systems described herein may allow for any number of combinations of criteria to be selected to generate customer rewards. Moreover, according to some embodiments, the criteria may be configurable to allow at least partial customization of the rewards programs. In some embodiments, the financial institution or other sponsoring entity may be permitted to customize and select criteria and/or associated thresholds or criteria levels, which may be applied to all customers or accounts associated with the particular rewards or to select customers or accounts. In some embodiments, customers themselves may customize the criteria. Additional details and examples are provided herein and will be realized based on the example embodiments described herein.

Rewards issued to customers may be any reward which may have perceived value to customers and which may encourage continued customer business with the financial institution (or other sponsoring entity). Example rewards include, but are not limited to, an impact to an account (e.g., credit, adjustment, discount, rate change, fee change, etc.), reward points, a reward value to an external system, discounts, coupons, special product or service offers, or any other incentivizing item or activity. In one embodiment, the reward may be applicable to one of the accounts analyzed as criteria for generating the reward or rewards. In another embodiment, a reward may be applicable to an unrelated account (or other merchant, etc.) other than one of the accounts analyzed as criteria. The account may be associated with the financial institution offering or otherwise sponsoring the rewards program, or may optionally be associated with a third-party not related to the financial institution.

It is appreciated that various aspects of the rewards program operations described herein can be performed by a service provider, a financial institution, or a combination thereof. The analysis of customers and/or accounts to determine if rewards rules are satisfied can be performed on a periodic basis (e.g., in a batch mode) or on an as-requested basis (e.g., in a real-time or near real-time mode), according to various example embodiments of the invention. As one example, the service provider may operate as an application service provider (“ASP”) that provides some or all of the rewards program operations described herein on behalf of a financial institution. For example, one or more users of a financial institution computer may interact with the service provider system to provide customer and/or account data and to customize or otherwise configure the data utilized by the relationship rewards system. In other embodiments, the relationship rewards system may be a unit of, or otherwise associated with, a financial institution that provides the relationship rewards program functionality to one or more units of the same financial institution, a subsidiary of the financial institution, or other financial institution(s) via networked computers. In yet another embodiment, the relationship rewards program operations described herein may be performed by one or more applications executed locally by a financial institution computer or computers. In this regard, the financial institution computer can access data either locally or via a network.

System Overview

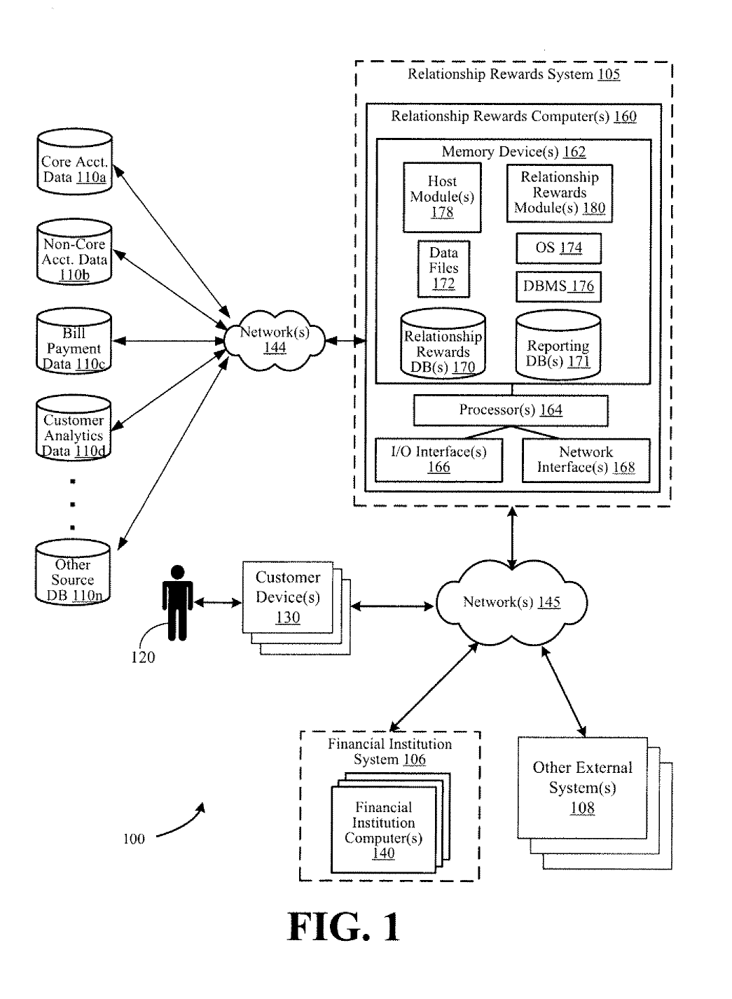

FIG. 1 illustrates an example system 100 operable to provide one or more rewards programs in accordance with an example embodiment of the invention. Although various computing devices and/or computers are illustrated in FIG. 1, it is appreciated that corresponding entities and/or individuals are associated with each of the computers illustrated. According to various embodiments, there may be: one or more relationship rewards systems 105, each associated with one or more relationship rewards computers 160, and one or more financial institution systems 106, each associated with one or more financial institution computers 140. In some embodiments, the relationship rewards system 105 may be in communication with one or more additional external systems 108 having one or more corresponding computers. External systems may be systems unrelated to the relationship rewards system 105 and the financial institution systems 106, such as systems associated with accounts or other programs that are not affiliated to the financial institution but to which rewards may be applied or for which criteria may be analyzed, as described in more detail herein. In addition, customer devices 130 may be operable to access or otherwise communicate with the relationship rewards system 105, such as to access rewards data and/or to configure rewards program preferences. In some embodiments, instead of, or in addition to, accessing the relationship rewards system 105, the customer devices 130 may be operable to access or otherwise communicate with one or more of the financial institution systems 106 and corresponding financial institution computers 140, such as to access account and/or reward information for accounts provided by the respective financial institution, or to access aspects of the rewards program provided by a financial institution system 106.

According to various embodiments, there may be any number of each entity type, and each entity may be associated with any number of suitable computers, computing devices, and/or other devices. For simplicity, the computers, devices, and/or entities may be referenced in the singular, but it is appreciated that the same description applies to embodiments including multiple computers, devices, and/or entities. Similarly, for each of the computers described herein, it is appreciated that the computer may include any number of suitable components and/or functionality. Moreover, although detailed descriptions of system components are provided for the relationship rewards system 105, it is appreciated that any of the financial institution systems 106, other external systems 108, and customer devices 130 may be configured in any suitable manner, which may be similar to that described herein for the relationship rewards system 105. In this regard, the financial institution computers or other external systems may provide computer-executable instructions, which may be accessed and executed by the one or more processors to provide some or all of the functionality described herein with respect to the financial institution systems 106, other external systems 108, or customer devices 130. Moreover, it is appreciated that some or all of the functionality described with reference to the relationship rewards system 105 may be performed by one or more financial institution systems 106 and/or by one or more other external systems 108, according to other embodiments.

As shown in FIG. 1, the relationship rewards system 105, the financial institution system 106, any other external systems 108, and the customer devices 130 may be in communication with each other via one or more suitable networks 145, which, as described below, can include one or more separate or shared private and/or public networks, including the Internet or a publicly switched telephone network. In addition, the relationship rewards system 105 may be operable to access one or more databases 110a-110n or other data storage devices via one or more networks 144. The networks 144 may be the same as, or different from, the networks 145. These components will now be discussed in further detail.

The relationship rewards system 105 may include any number of relationship rewards computers 160 operable to receive certain account, transaction, or other activity data associated with accounts and/or customers of one or more financial institutions, and further to provide relationship rewards programs based at least in part upon the received data. In addition, the one or more relationship rewards computers 160 may communicate with any number of financial institution systems 106 and associated financial institution computers 140, and/or optionally with one or more customer devices 130, to receive rewards rules and corresponding criteria for providing relationship rewards programs as described herein, as well as to provide one or more rewards generated for respective customers or accounts to any number of financial institution systems 106 and/or customer devices 130.

A relationship rewards computer 160 may be any suitable processor-driven device, such as, but not limited to, a server computer, a mainframe computer, one or more networked computers, a desktop computer, a personal computer, a digital assistant, a personal digital assistant, a digital tablet, a mobile device, a smart phone, an Internet appliance, an application-specific circuit, a microcontroller, a minicomputer, or any other processor-based device. The execution of suitable computer-implemented instructions by the relationship rewards computer 160 may form a special purpose computer or other particular machine that is operable to provide relationship rewards programs, as well as the receipt and output of data associated with the relationship rewards program. Although a single relationship rewards computer 160 is described herein, the operations and/or control of the relationship rewards computer 160 may be distributed among any number of computers and/or processing components.

In addition to having one or more processors 164, the relationship rewards computer 160 may include one or more memory devices 162, one or more input/output (“I/O”) interfaces 166, and one or more network interfaces 168. The memory devices 162 may be any suitable memory devices, for example, caches, read-only memory devices, random access memory devices, magnetic storage devices, removable storage devices, etc. Additionally, any number of logical data storage constructs may be stored as desired within the memory devices 162, such as any suitable database, for example, one or more relationship rewards databases 170 and/or one or more reporting databases 171. In addition, or alternatively, while the databases 110a-110n are depicted as being accessed via the network 144, in some embodiments, any of the databases 110a-110n may be stored within the memory devices 162 without departing from embodiments of the invention. In yet another embodiment, one or more of the databases 110a-110n may be a component of or otherwise reside with one or more of the financial institution systems 106 or another external system 108. Moreover, in some embodiments, either of the relationship rewards databases 170 or the reporting databases 171 may be provided within a memory device or other storage device of a different computer system and accessed over a network. The memory devices 162 may further store a wide variety of data, which may be stored as data files 172. Additionally, the memory devices 162 may store computer-executable instructions and/or various program modules utilized by the relationship rewards computer 160, for example, an operating system (“OS”) 174, a database management system (“DBMS”) 176, a relationship rewards module 180, and/or one or more host modules 178.

The data files 172 and/or the relationship rewards database 170 may include any suitable data that facilitates the receipt or processing of certain data utilized with or by the rewards processing, which may include rewards rules, criteria, account information, customer information, financial institution information, customized configurations, user preferences, templates, and/or any other data to be utilized with the rewards processing, as well as one or more rewards or other results generated by the relationship rewards processing. For example, the data files 172 and/or relationship rewards database 170 may include data derived or received from the databases 110a-110n, any rules, criteria, options, constraints, or preferences received from one or more financial institution systems 106 or one or more customer devices 130, as well as processing results from the performed rewards operations that are made available to one or more financial institution systems 106, one or more other external systems 108, and/or one or more customer devices 130. The relationship rewards module 180 may store relationship rewards rules and corresponding criteria, which generally provide associations between accounts, account types, customers, and/or customer types and rewards programs, as well as the types of rewards to be generated and the criteria to be satisfied to generate the respective rewards. The relationship rewards module 180 may include algorithms, processing logic, and/or business rules associated with implementing the relationship rewards programs. In some example embodiments, the relationship rewards module 180 may store processing logic, business rules, and/or other software that is less prone to change over time, while other logic, rules, criteria, and/or preferences that are more likely to change or be modified may be stored in data files 172 and/or in the relationship rewards database 170. The one or more reporting databases 171 may also store some or all of the rewards program data, serving as a separate data repository to support reporting and data mining without impacting the performance of the primary rewards program operations and/or the relationship rewards database 170. For example, the reporting database 171 may be updated periodically (e.g., by batch processes), or updated in real-time or near real-time, with rewards data, such as after performing an analysis to determine which rewards are to be provided and/or after providing rewards. Many variations of the relationship rewards database 170, the reporting database 171, the data files 172, and/or the relationship rewards module 180 can be provided in accordance with example embodiments of the invention. It is appreciated that the depiction of the relationship rewards database 170 and the reporting database 171 as separate databases from the data files 172 and/or any other data storage means is provided for illustrative purposes, and that any data may be stored in any arrangement, separate or together with other data stored by the relationship rewards computer 160.

The operating system (“OS”) 174 may be any suitable software module that controls the general operation of the relationship rewards computer 160. The OS 174 may also facilitate the execution of other software modules by the one or more processors 164, for example, the relationship rewards module 180 and/or the host modules 178. The OS 174 may be, but is not limited to, Microsoft Windows®, Apple OSX™, Linux, Unix, or a mainframe operating system, such as, but not limited to, middleware, integration programming, configuration tools, web servers and the like. The host modules 178 may include any number of suitable host modules that manage interactions and communications between the relationship rewards system 105 and external systems, such as the financial institution system 106, the customer devices 130, or any other external systems 108, such as, but not limited to, middleware, integration programming, configuration tools, web servers and the like. In this regard, the host module 178 can interface with other modules in order to facilitate the receipt of data from the databases 110a-110n, as well as rewards rule configurations, criteria, options, constraints, and/or other preferences from the financial institution system 106 and/or from the customer devices 130. The host module 178 may also manage requests from one or more financial institutions to perform one or more rewards analysis for one or more customers and/or one or more accounts, and requests to receive one or more rewards results from the performed analyses. Additionally, in certain embodiments, the host modules 178 may be configured to generate and/or to present a wide variety of different interfaces and/or graphical user interfaces. Interfaces generated and/or presented may include, but are not limited to, interfaces to present data to and/or to receive data from financial institution systems 106, customer devices 130, other external systems 108, and/or directly with the relationship rewards system 105. An interface can be in the form of one or more browser-based or Internet-based web pages, although interfaces can also be presented through specialized software programs (e.g., a stand-alone application, an applet, a mobile device application, etc.), according to various example embodiments. It will be appreciated that the interface can be formatted for display on a mobile device (e.g., a personal communications device, a personal digital assistant, a mobile phone, a smart phone, etc.) or non-mobile device (e.g., a desktop computer, a server computer, etc.), according to an example embodiment of the invention. For example, the customer devices 130 may include mobile devices or non-mobile devices to provide increased access to the relationship rewards system 105. The interface may be associated with security settings to enable access by certain registered users of the relationship rewards system 105, the financial institution system 106, and/or the other external systems 108. As desired, a private interface may be branded in accordance with specifications and/or preferences of a partner entity. Additionally, as desired in certain embodiments, the host modules 178 may be configured to provide a web services interface layer to another entity or component of the system 100.

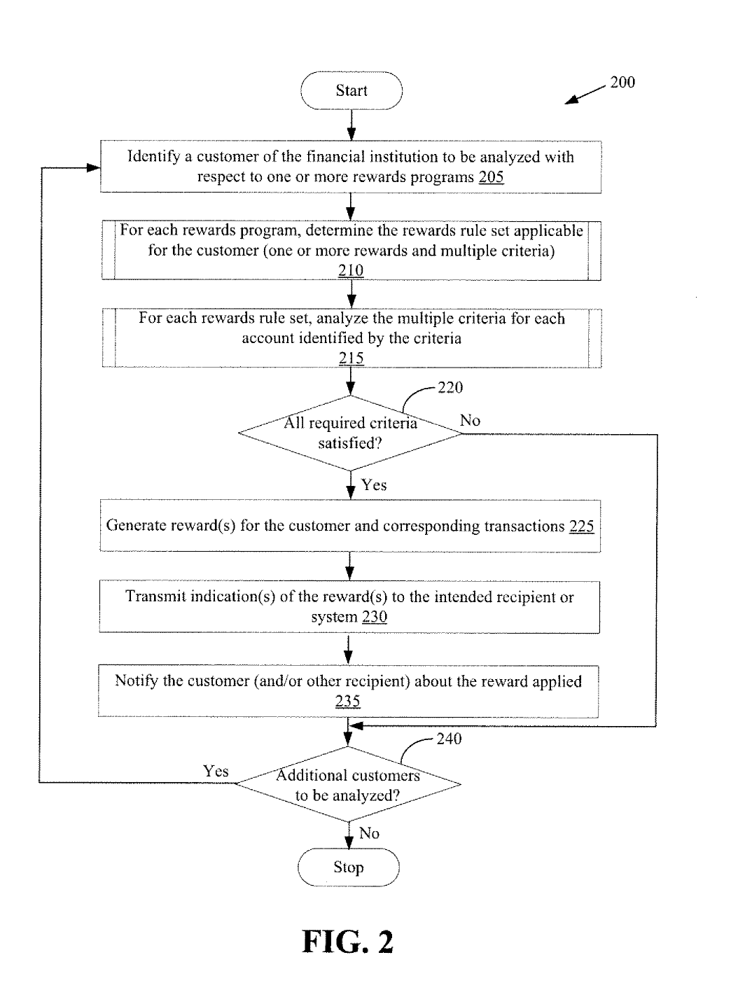

The relationship rewards module 180 may be operable, configured, and/or programmed to receive data from relationship rewards database 170 or data files 172 to determine whether a rewards program applies to one or more accounts and/or one or more customers, and to analyze the customer and/or account activity in view of previously configured rewards rules and corresponding criteria to determine whether one or more rewards are to be generated. Additional details of the operations of the operating logic and functionality of the relationship rewards module 180 and/or the relationship rewards system 105 are provided below with reference to FIGS. 2-5.

With continued reference to the relationship rewards computer 160, the one or more I/O interfaces 166 may facilitate communication between the relationship rewards computer 160 and one or more input/output devices; for example, one or more user interface devices, such as a display, keypad, mouse, pointing device, control panel, touch screen display, remote control, microphone, speaker, etc., that facilitate user interaction with the relationship rewards computer 160. The one or more network interfaces 168 may facilitate connection of the relationship rewards computer 160 to one or more suitable networks, for example, the network(s) 144, 145 illustrated in FIG. 1, or local area network(s) within the relationship rewards system 105. In this regard, the relationship rewards computer 160 may receive and/or communicate information to other components of the system 100, such as the databases 110a-110n (either directly or via one or more computers managing databases 110a-110n), the financial institution systems 106, the customer devices 130, and/or other external systems 108. As desired, any number of web pages, interface screens, and/or other presentations (e.g., graphical user interfaces, etc.) may be provided or presented for interaction with the relationship rewards system 105 via the network 145 and/or the network 144.

The databases 110a-110n can provide a variety of transaction and non-transaction data associated with accounts, customers, financial institutions, and/or products that may be analyzed in accordance with the relationship rewards operations described herein. In an example embodiment of the invention, the databases 110a-110n may include one or more of: a core account database 110a, a non-core account database 110b, a bill payment database 110e, a customer analytics database 110d, and/or one or more other source databases 110n. Although FIG. 1 represents these databases 110a-110n as databases that are accessed remotely from the relationship rewards system 105, in some embodiments, these databases 110a-110n (or the content provided thereby) may be accessed by the relationship rewards system 105 through one or more other application systems. For example, a core banking system may provide access to the core account database 110a and a non-core banking system may provide access to the non-core account database 110b, either of which may be operated by a financial institution or a service provider system, a bill payment system may provide access to the bill payment database 110c, which may typically be operated by a service provider but can be operated by a financial institution, and a core banking system, customer system, or analytics system may provide access to the customer analytics database 110d. In one example embodiment of the invention, each of the databases 110a-110n may include the following information illustrated below:

Core account database 110a
Types of products/accounts/services can include:
i. demand deposit accounts
ii. savings accounts
iii. time deposit accounts (e.g., certificate of deposit accounts, etc.)
iv. lines of credit (e.g., home equity line of credit, etc.)
v. business loans
vi. consumer loans
vii. other product/account/services available
Information associated with one or more specific types of products/accounts/services can include:
i. balance (e.g., original principal, current, average daily, etc.)
ii. interest rate
iii. term
iv. maturity date
v. periodic payment due (e.g., amount due monthly, bi-weekly, annually, etc.)
vi. other product/account/service specific information
Transaction-specific information can include:
i. type of transaction (e.g., debit/purchase, credit/return, signature-based transaction, PIN-based transaction, fee, interest, etc.)
ii. date of transaction (e.g., transaction date, posting date, etc.)
iii. transaction amount
iv. transaction channel (e.g., point of sale, online, etc.)
v. associated entity or product information (e.g., payor/payee, merchant identifier, merchant category, merchant descriptor, product identifier, product descriptor, product category, etc.)
vi. other descriptive transaction content
Customer information (associated with a specific product/service/account or institution-wide) can include:
i. customer demographic information (e.g., age, gender, address, occupation, birthday, etc.)
ii. customer contact/identifier (e.g., contact information, email address, phone number, etc.)
iii. customer status
iv. customer segments
v. customer channel preferences (e.g., paper mailing, email, etc.)
vi, customer contact preferences (e.g., email, phone, paper mailing, online chat, etc.)
vii. customer service options/programs/enrollments (e.g., electronic statements, online banking, mobile application, electronic bill pay, etc.)
viii. anniversary or other milestones (e.g., with the financial institution, associated with a specific product/service/account, etc.)
ix. other customer related data

Non-core account database 110b
Types of non-core account/product/service information can include:
i. credit accounts (e.g., for card issuers, etc.)
ii. investment accounts
iii. trust accounts
iv. insurance accounts
v. other types of non-core accounts/products/services
Information associated with one or more specific types of products/accounts/services can include:
i. credit limit
ii. type of investment account
iii. basis versus position
iv. net asset value
v. ticker symbol or other security identifier
vi. type of policy (e.g., term, life, auto, home, etc.)
vii. policy amounts (e.g., premiums, deductibles, coverage amounts, options, exclusions, etc.)
viii. other non-core account information

Bill payment database 110e
Types of bill payment products/accounts/services can include:
i. consumer bill payment
ii. business bill payment
iii. bill presentment
iv. person-to-person payment
v. other types of bill payment or online banking products
Bill payment data can include:
i. transaction type (e.g., debit/payment to payee, credit received from payee, recurring, one-time, autopay, etc.)
ii. transaction channel (e.g., online, originating website or service, originating institution, originating service provider, mobile or non-mobile, in-person, telephone, etc.)
iii. bill payment date
iv. bill payment amount
v. payee identifier
vi. source account (e.g., credit card, debit card, deposit account, etc.)
vii. number of failed bill payment transactions
viii. amount(s) of failed bill payment transactions
ix. date(s) of failed bill payment transactions
x. number of personal payees
xi. number of electronic billers
xii. number of personal payees that are unactivated electronic billers
xiii. other bill payment information

Customer analytics database 110d
Predictive modeling, analytical calculations, and/or customer history information can include or relate to:
i. credit score
ii. attrition risk probability or score
iii. propensity or probability to buy (e.g., for a product specific or service, etc.)
iv. current customer value
v. future customer value
vi. total value
vii. share of wallet (e.g., percentage of total customer's business conducted with financial institution, etc.)
viii. key drivers (e.g., activities typically influencing customer activity)
ix. recommended next action
x. other customer demographic and/or analytic information

Other source database 110n
Other customer, account, transaction, and/or non-transaction data from a variety of other financial institutions and affiliated institutions, including credit card institutions, credit reporting agencies, loan providers/servicers, or other external, unaffiliated systems
Other customer, account, transaction, and/or non-transaction data relating to investment products, insurance products, and other banking/financial institution products

It will be appreciated that the account, customer, and/or transaction data for one or more of the respective databases 110a-110n can be grouped according to account, customer, relevant time period, or any other grouping techniques, according to various example embodiments.

Although not described or illustrated in detail, each financial institution system 106 and corresponding financial institution computer or computers 140, and/or each other external system 108, may be configured in the same or similar manner as described for the relationship rewards system 105. For example, a financial institution system 106 and/or other external system 108 may include one or more processor-based computers operable to store and execute computer-executable instructions, each having one or more processors, memories, I/O interfaces, network interfaces, operating systems, data files, databases or other data storage means, DBMSs, host modules and other operating logic to perform some or all of the same or similar functions as are described herein with reference to the relationship rewards system 105.

Likewise, each customer device 130 may be configured in a similar manner as described in detail with reference to the relationship rewards computer 160, and may be one or more processor-based computers operable to store and execute computer-executable instructions, each having one or more processors, memories, I/O interfaces, network interfaces, operating systems, data files, databases or other data storage means, DBMSs, host modules and other operating logic to perforin some or all of the functions described herein with reference to the customer devices 130 and/or performed by customers. According to one embodiment, a customer device 130 may be a mobile device (e.g., a personal communications device, like a mobile phone, a smart phone, a personal digital assistant, a tablet computer, a laptop computer, etc.) or a non-mobile device (e.g., a desktop computer, a server computer, etc.). Moreover, some or all of the functionality provided by the customer devices 130 may be performed with the use of a telephone over a telecommunications network (e.g., wireless or wired PSTN network, etc.), such as when communicating with a live customer service agent associated with a financial institution or with the relationship rewards system (e.g., a service provider, etc.), or when communicating via an interactive voice response unit (“IVR”), instead of or in addition to communications over a network 145 using a computer or other processor-based device, according to one embodiment.

The networks 144, 145 may include any number of telecommunication and/or data networks, whether public, private, or a combination thereof, including but not limited to, the Internet, a local area network, a wide area network, an intranet, intermediate handheld data transfer devices, public switched telephone networks, and/or any combination thereof and may be wired and/or wireless. The networks 144, 145 may also allow for real-time, off-line, and/or batch transactions to be transmitted thereover. Due to network connectivity, various methodologies described herein may be practiced in the context of distributed computing environments. Although the system 100 is shown for simplicity as including networks 144, 145, it is to be understood that any other network configuration is possible, which may optionally include a plurality of networks for each of networks 144, 145, each with devices such as gateways and routers, for providing connectivity between or among networks.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

Operational Overview

FIG. 2 illustrates a flow diagram of an example method for providing relationship rewards programs for one or more customers, according to an example embodiment of the invention. The method 200 may be performed by a relationship rewards system, such as the relationship rewards system 105, including one or more relationship rewards computers 160, described with reference to FIG. 1, according to one embodiment. The relationship rewards system 105 may access a host module 178 and/or a relationship rewards module 180, and any of the databases or other data sources described with reference to FIG. 1. As stated above, this relationship rewards system may be associated with a third-party service provider performing the operations of the method 200 (and other methods described herein) for or on behalf of a financial institution (or other subscribing entity), according to one embodiment. However, in other embodiments, the relationship rewards system, or at least a portion thereof, may be associated with the financial institution, such as if the financial institution is operating the rewards program internally. The operations of the method 200 may be performed serially, such as when operating in a batch mode, or may be performed in real-time or near real-time, such as in response to a particular inquiry or activity that triggers the rewards program functionality.

The method 200 may begin at block 205, in which each customer whose activities are to be analyzed with respect to one or more rewards program can be identified. It is appreciated that, in some embodiments, the relationship rewards system is configured to analyze each customer and corresponding customer activities and information (e.g., accounts, products, programs, services, demographics, etc.) for each rewards program applicable to the customer. The analysis can be performed in a sequential manner, completing the analysis for each customer and all applicable rewards programs before proceeding to the next customer. Though, in other embodiments, the relationship rewards system may be configured to analyze customers concurrently. In yet other embodiments, the relationship rewards system may be configured to first identify a rewards program and analyze each customer and/or account applicable to the rewards program before proceeding to the next rewards program.

According to various embodiments, rewards program information may be stored by and accessed from a database or other storage device, such as the relationship rewards database 170 described with reference to FIG. 1. The database or other data storage device may store associations identifying which rewards programs (and thus the corresponding rewards rules) provided by a financial institution are applicable to which customers. Associations between the rewards programs and accounts, in addition to or instead of with customers, may be stored to allow determining which rewards programs are to be analyzed for which accounts, and, thus, for which customers. In addition, or alternatively, associations may be provided between a rewards program and a customer type (or account type), allowing a customer to be associated with a rewards program by way of the customer type (or account type), whereby all customers of the same type or accounts of the same type will be associated with the rewards program. Accordingly, at block 205, the relationship rewards system selects customers that are associated with one or more rewards programs to be analyzed for determining whether one or more rewards are to be provided to the respective customers.

It is further appreciated that, in some embodiments, customers may affirmatively enroll in, or otherwise be aware of their participation in, the rewards program. In other embodiments, however, customers may not be aware of the rewards program or that their activity may make them eligible to receive one or more rewards. For example, a financial institution may configure a rewards program that is intended to award or encourage certain activities or other behavior by its customers, and implement the rewards program without explicitly notifying or informing the customers.

After the customer is identified, block 210 follows. At block 210, for each reward program associated with the customer (as identified at block 205), the corresponding rewards rules are determined. According to one embodiment, each reward program has a single rewards rule set that identifies at least one reward to be provided and the criteria to be satisfied to provide the reward. If the reward rules differ, then a different rewards program can be defined. Though, in other embodiments, a rewards program may have multiple and different rewards rule sets, and each set is to be analyzed. Thus, after identifying the customer, the relationship rewards system determines the rewards rules for each rewards program to be analyzed for the customer. The rewards rule information, including the reward or rewards to be provided and the criteria to be satisfied, may be stored by and accessed from a database or other storage device, such as the relationship rewards database 170 described with reference to FIG. 1.

According to one embodiment, a rewards rule may identify one reward with multiple criteria that are to be satisfied for the reward to be provided. Each of the criteria may be associated with an account of the customer, or may be associated with more general information, such as customer-related information, analytics information, and the like. In some embodiments, different criteria are associated with different accounts of the customer, such that the rewards program allows a financial institution to provide rewards for customers that have multiple accounts with and/or use multiple services of the financial institution. Thus, the criteria may be based on a number of factors, including, but not limited to, transaction information, status information, account type, services, and/or products that are associated with the respective account, and/or with information describing the customer or the customer's tendencies, such as, but not limited to, customer demographic information, customer analytic information, customer trends, customer forecasts, and the like. According to other embodiments, the rewards rules for a rewards program may indicate that multiple rewards can be provided, with each reward having a different set of criteria. Thus, in these embodiments, the relationship rewards system will determine the criteria for each of the multiple possible rewards.

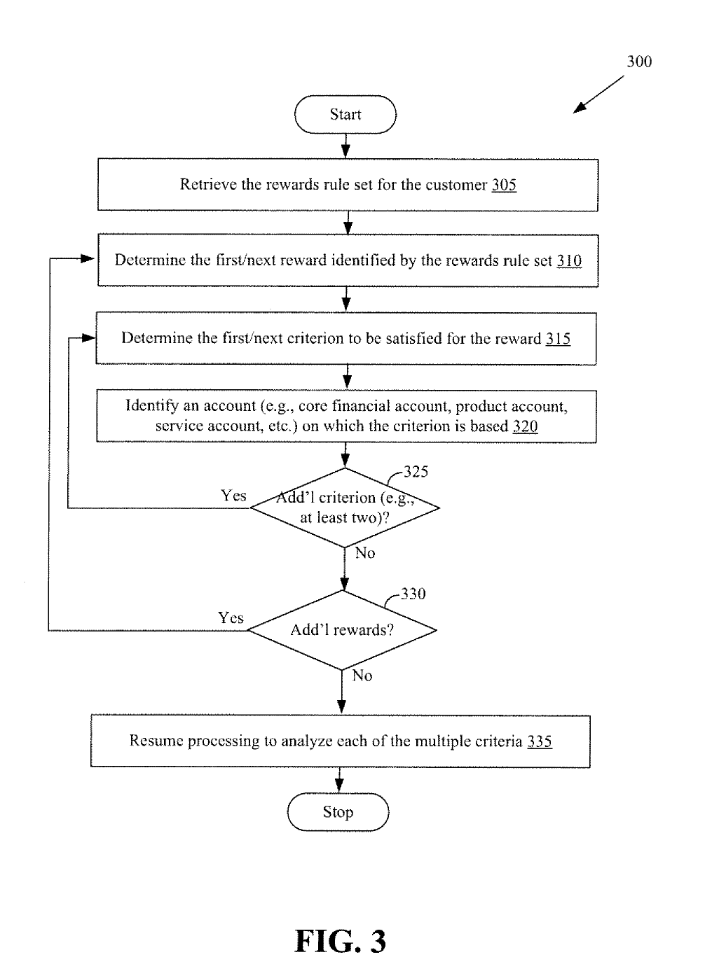

Accordingly, after block 210, the relationship rewards system will have retrieved all of the rewards rule data, include the rewards to be provided and the criteria to be satisfied, to be used for analyzing the customer and account information. The operations of determining the rewards rules to be analyzed are described in more detail with reference to FIG. 3.

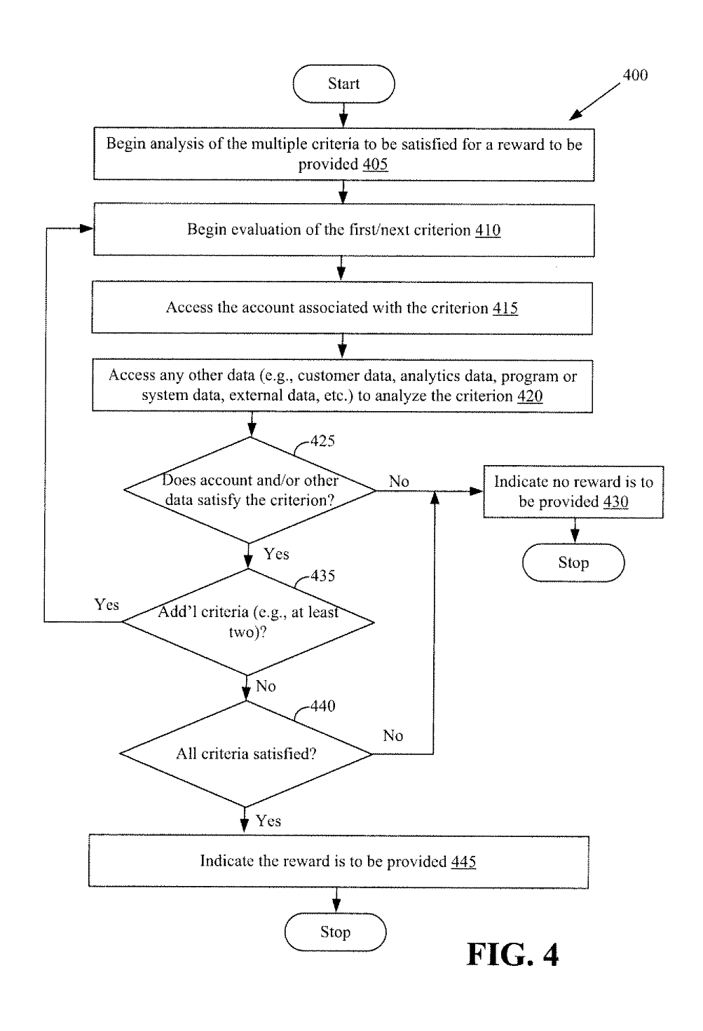

Following block 210 is block 215, in which the relationship rewards system analyzes the rewards rules, particularly the criteria, identified at block 210 to determine whether the identified reward or rewards are to be provided. As described in more detail with reference to FIG. 4, the relationship rewards system may access a number of data sources, or otherwise retrieve data that is provided by one or more data sources, such as if provided locally to the relationship rewards system via a batch process. The data sources may include, but are not limited to, one or more core account databases 110a, one or more non-core account databases 110b, one or more bill payment databases 110c, one or more customer analytics databases 110d, or any other data source or sources 110n, such as those described with reference to FIG. 1. According to various embodiments, the relationship rewards system may not access or otherwise retrieve data associated with all of the aforementioned databases 110a-110n or other data sources. It may be that only one or a subset of these data sources are accessed, which will depend upon the specific criteria indicated by the rewards rules identified at block 210. Moreover, as stated, the data provided by one or more of the data sources 110a-110n may be previously transmitted to the relationship rewards system 105, such as via a batch process, and stored locally for subsequent access when analyzing the rewards rules.

Any of these databases 110a-110n (or other data sources) may be associated with the financial institution or based on data provided by the financial institution. For example, in one embodiment in which the relationship rewards system is operated by a service provider, the system may electronically access one or more of the aforementioned databases 110a-110n associated with a financial institution over a network, such as the network 144, when performing the analysis at block 215. In another embodiment, the relationship rewards system may receive data from the respective financial institution and populate internal databases, such as by batch processing, for example. In yet another embodiment, such as if the relationship rewards system is operated by the financial institution, the aforementioned databases 110a-110n or other data sources may be a component of, or associated with, the relationship rewards system. It is further appreciated that, according to some embodiments, one or more of these data sources (or data associated therewith) may be provided by an external system that is not associated with the financial institution or with a service provider operating the rewards program, such as, but not limited to, a third-party service provider, a reporting entity, a data analytics entity, and the like.

Upon receiving or retrieving the data, the relationship rewards system analyzes the data in view of the criteria indicated by the rewards rules identified at block 210, which is described in more detail with reference to FIG. 4. At decision block 220, it is determined whether the criteria are satisfied. If the required criteria are not satisfied, then the associated reward is not to be provided, and the operations may continue to decision block 240, to repeat back to block 205 at some subsequent time if other customers (or accounts) are to be analyzed. If, however, the criteria are satisfied, then operations continue to blocks 225-240.

At block 225, the relationship rewards system may generate one or more corresponding transactions for the reward to be provided to the customer (or otherwise indicate that the reward is to be provided for the customer), which may depend in part on the type of reward to be provided. For example, as part of generating the reward, one or more transactions (e.g., an electronic funds transfer credit transaction, etc.) may be required to apply the reward. In some embodiments, a notification or other indication may be all that is required. Accordingly, the transactions or notifications may be generated and compiled for transmitting to the respective recipient or system. In one embodiment, these transactions may be compiled into one or more files, such as batch files for application to the corresponding account's system platform, or for real-time notification (e.g., to a message queue, a web service, etc.) to and/or update of the corresponding account's system platform.

It is appreciated that, depending upon the rewards system model (e.g., whether operated by a service provider or by the financial institution) and upon the reward to be provided, the operations performed at block 225 may vary greatly. For example, if the relationship rewards system is operated by a service provider, reward data may be stored in memory (e.g., in the relationship rewards database 170, in a reporting database 171, etc.), and at least one transaction may be generated and transmitted to the financial institution to be applied to the respective account or accounts to which the reward pertains. As another example, if the relationship rewards system is operated by the financial institution, the reward data may be stored, such as for record keeping and/or reporting, and one or more internal databases or other systems may be updated, such as updating a core account database to apply the reward. In addition, in some embodiments, the customer may be notified, such as after the reward is applied or if the reward is provided as an offer that calls for a response by the customer prior to applying the reward.

Likewise, the operations at block 225 may vary depending upon the type of reward or rewards provided. As briefly described, any number of reward types may be provided, such as to impact a core account or non-core account associated with the financial institution, to impact a core account or non-core account not associated with the financial institution (e.g., an account of the customer at another financial institution, etc.), to impact or otherwise be associated with a product or service offered by the financial institution, to impact a rewards program, or to impact any other offer or incentive, which may be directly or indirectly provided to the customer. Example rewards include, but are not limited to, a credit (e.g., for a monetary amount) to one or more accounts, such as a one time or recurring rebate; an adjustment to a rate or fee associated with one or more accounts, such as a fee refund or waiver, a service charge refund or waiver, an interest rate discount (e.g., to an interest-bearing checking account, on a loan, etc.); a discount or offer associated with a product or service provided by the financial institution; a discount, coupon, or other offer for a different product or service; a money back reward (e.g., a check or deposit, etc.); one or more points or other credits for use in association with a rewards program (e.g., a rewards program of the financial institution or an external rewards program not related to the financial institution); or a reward (e.g., a gift, donation, etc.) to a third-party entity not related to the financial institution on behalf of the customer.

In one embodiment, the reward may be applicable to one of the accounts analyzed according to the criteria at block 220 for generating the reward or rewards. In another embodiment, a reward may be applicable to an account unrelated to any of the accounts analyzed by the criteria. The reward may be applied to an account that is associated with the financial institution providing the rewards program. In other embodiments, the reward may optionally be applied to a third-party account or other program that is not related to the financial institution providing the rewards program (e.g., paying down or otherwise transferring funds to a loan or outstanding credit of the customer with an account outside of the sponsoring financial institution, etc.). For example, as mentioned, in one embodiment, the reward may credit one or more points or other value to an existing rewards program (which may or may not be associated with the financial institution). According to yet another embodiment, multiple rewards can be generated, whereby the multiple rewards are each applied to different accounts, which may or may not be associated with the financial institution providing the rewards program.

Accordingly, the relationship rewards system described herein differs from conventional rewards programs because it allows generating rewards program points or other program value on activities beyond just the debit, credit, or other financial accounts with which the rewards program is associated. Any of the criteria described herein may be utilized to generate one or more rewards points or other value for an existing rewards program, providing the customer increased opportunities to generate more rewards points and, thus, further encouraging customer loyalty.

In addition, according to one embodiment, one of the transactions generated at block 225 may be to update the relationship rewards system with the rewards data and to indicate that the reward has been generated. This update may be useful to maintain rewards records, such as if the rewards rule criteria depend, at least in part, on past reward activity (e.g., whether a reward has previously been provided, types of past rewards, amounts of past rewards, number of past rewards provided, associated dates, etc). In one embodiment, some or all of the rewards data may be extracted and transmitted to a separate data repository (e.g., a separate reporting database 171, etc.) to support reporting and data mining without impacting the performance of the primary rewards program operations and/or the relationship rewards database 170. A separate data repository may be periodically updated or updated in real-time or near real-time with rewards data. According to various embodiments, the separate data repository may be accessed by a number of different users, each of whom may have privileges to access different levels of data detail, including, but not limited to, a financial institution operator, a service provider operator, a customer, or an external third-party entity (e.g., for analytics, outsourced reporting, etc.). It is appreciated, however, that in other embodiments some or all of the rewards data reporting may be performed on data stored in the primary data sources, such as the relationship rewards database 170, without using a separate data repository.

Block 230 may be performed subsequent to block 225, in which the relationship rewards system may transmit any of the transactions or other indications of the reward or rewards generated to intended recipients or other systems associated therewith for applying the reward or rewards. As described with reference to block 225, the transactions or other indications may be to the financial institution system, directly to the customer, or to a third-party recipient or recipient's system.

Following block 230, is block 235, in which one or more notifications regarding the reward or rewards may optionally be transmitted. The notifications may include some or all of the details of the reward and any corresponding transactions (e.g., monetary credit, rate or fee reduction, rewards points, etc.). According to one embodiment, the indications or notifications may be utilized to provide notice of a reward upon or after applying the reward. For example, the indication or notification may be transmitted to the customer, to the reward recipient if different from the customer, to a system or program operator of the financial institution, and/or to an operator of the relationship rewards system. In another embodiment, however, the notification may be transmitted at block 230 to notify a recipient (e.g., the customer) of any additional actions to be performed prior to applying or otherwise providing the reward. For example, part of the transactions generated at block 225 may include an activation or opt-in request, which may include terms or additional actions to be performed by the customer (or other recipient of the reward).

The notifications may be provided at block 235 according to any number of communications techniques, such as, but not limited to, electronic notifications over a network (e.g., an email, a website notification, a notification via an online banking application or a rewards system application, a live chat message, wireless communications, such as short messaging service or multi-media messaging service, etc.), telephone notifications (e.g., by a live customer service agent, an interactive voice response unit, etc.), written correspondence (e.g., mailed, etc.), kiosk or point-of-sale terminal notifications (e.g., when performing a transaction using the account to which the reward is applied, etc.), and the like. In some embodiments, electronic notifications that call for additional responses or activities by the customer before the reward can be applied may include one or more hyperlinks to the financial institution system or to a service provider system to complete the called-for responses or activities (e.g., to provide an affirmative opt-in, to enroll in a program or service, to perform a transaction, such as a deposit or transfer, etc.).

After generating one or more transactions, transmitting indications, and optionally notifying the customers or other recipients, the method 200 may continue to decision block 240. At decision block 240, it is determined whether any additional customers (or accounts) are to be analyzed. If so, operations repeat back to block 205 where the next customer (or account) is selected for analysis. If not, the method 200 may end after block 240, having identified and analyzed whether a customer's accounts and/or other related information satisfy rewards program criteria to provide a reward for that customer.

FIG. 3 illustrates a flow diagram of an example method for retrieving the rewards rules and determining those applicable to the current customer or account being analyzed, which include the rewards to be provided and the criteria to be satisfied, according to one example embodiment. This method 300 provides a more detailed example of the operations described with reference to block 210 of FIG. 2. According to one embodiment, the method 300 may be performed by the relationship rewards system, such as the relationship rewards system 105, which may access a host module 178 and/or a relationship rewards module 180 and relationship rewards database 170, or any other data sources, such as those described with reference to FIG. 1. It is appreciated that many variations of FIG. 3 are available in accordance with various example embodiments.

It is appreciated that the operations described for the method 300 may not be performed in an iterative or stepwise fashion, and that little or no analysis may be performed, to retrieve the relevant rewards rule information. For example, the operations and relevant information described with reference to FIG. 300 may be retrieved simply by one or more reading operations retrieving the relevant information from memory that is associated with the respective rewards program and applicable for the customer or account being analyzed. However, the operations of the method 300 are provided to further illustrate various example rewards program rules configuration and logical associations that are possible, according to various embodiments.

The method 300 may begin at block 305, in which the relationship rewards system retrieves the rewards rules to be analyzed. As described with reference to FIG. 2, a rewards program may associate customers (or customer types) to rewards rules, or in other embodiments, accounts (or account types) may be associated with rewards rules. Accordingly, the rewards rules can be retrieved at block 305 based on any of a number of associations, depending upon the implementation of the rewards program. The rewards rules retrieved can thus include or otherwise identify the reward or rewards to be provided and the associated criteria that are to be satisfied to provide each of the rewards. The rewards rules may be retrieved from the relationship rewards database 170, according to one embodiment; though, in other embodiments, the rewards rules may be stored in any other data storage device.

Following block 305 is block 310, in which the relationship rewards system determines, or otherwise retrieves an identify of, a reward to be provided as identified by the rewards rules. It is appreciated that, in some implementations, more than one reward may be provided, each of which may be based on the same set of criteria or on different criteria. If more than one reward is provided, the operations of the method 300 will repeat for each reward to be provided, as indicated at decision block 330.

Upon determining the reward to be provided, at block 315, the corresponding criteria to be satisfied are retrieved or otherwise determined for the reward determined at block 310. As briefly discussed, according to various embodiments, any number and combination of criteria may be required for a reward to be generated and provided for a customer. The previous description of the example content provided by the various data sources 110a-110n provides examples of possible data that can form the basis of one or more criteria, according to various embodiments. The criteria may be based at least in part on one or more of the following general criteria types: account transaction information; account status information; account types; product, program, or service information; customer information; or any combination thereof or other suitable information, as desired. Any one or more of these criteria types may be associated with or derived from a single account or from multiple accounts, according to various embodiments. In addition, the account or accounts from which the information is derived may be associated with the financial institution sponsoring the rewards program, or may be associated with an external system that may not be affiliated with or otherwise associated with the financial institution, according to various embodiments. Accordingly, the relationship rewards system may be configured to analyze a variety of different possible factors to identify and incentivize customer behavior. In sonic embodiments, the relationship rewards system may include additional programming logic that allows considering these more complex combinations of criteria, such as combining or otherwise compiling data from multiple different accounts, performing mathematical operations on data associated with multiple account or even different financial institutions (e.g., calculating balances, investments, limits, etc. based on multiple different accounts, etc.), and the like. Not being limited to criteria based only on activity associated with a single account, such as the same account which is to be rewarded, the rewards program according to these embodiments has the flexibility to capture a wide variety of activities and customer behavior to reward, which may optionally be based on combinations of data associated with, or derived from, different accounts and/or customer-related information.

Thus, the relationship rewards system can retrieve or otherwise determine each criterion at block 315 and the account associated with the criterion, if a specific account (or account type) is identified, at block 320. It is appreciated that, according to some embodiments, there may not be a direct association with a specific account of the customer or a specific account type or types, but instead criteria may be provided that can be satisfied by any of the customer's accounts. Thus, all of (or a portion of) the customer's accounts will be analyzed with regard to the criteria determined at block 315, not just a specific account.

If there are multiple criteria indicated by the rewards rule, and not all criteria have been determined, then operations repeat from decision block 325 back to block 315, and the next criterion is retrieved or otherwise determined. The operations of blocks 315-325 will be repeated until all criteria are determined for the reward identified at block 310. If there are not multiple criteria, or all criteria have been determined, then operations proceed to decision block 330. It is appreciated that the operations described with reference to blocks 315-325 may not be performed in a stepwise fashion or iteratively, but instead may result from one or more reading operations retrieving the relevant information from memory, such as from the relationship rewards database 170 described with reference to FIG. 1. For example, in one embodiment, each rewards rule set may have multiple data entries associated therewith to identify the reward or rewards and corresponding criteria. Thus, the relationship rewards system may retrieve the rewards and criteria information by simply retrieving the data associated with a respective rewards program from memory.

At decision block 330, it is determined whether any additional rewards are to be provided. For example, according to one embodiment, a rewards rule set may identify two rewards, each of which has a distinct set of criteria associated therewith. One example of such a configuration would be a tiered rewards program whereby different rewards are available upon satisfying different sets of criteria, as previously described. Thus, at decision block 330, operations repeat to block 310 to determine the next reward and then to blocks 315-320 to determine the one or more criteria to be satisfied for this new reward and associated accounts. The operations will repeat back to block 310 until all rewards and associated criteria and accounts are identified.

Accordingly, after decision block 330, operations continue to block 335 for analyzing the multiple criteria that have been identified, such as is generally described with reference to FIG. 2 beginning with block 215, and more particularly described with reference to FIG. 4. The method 300 may therefore end after block 335, having retrieved all of the rewards rule information, including rewards and corresponding criteria, for each rewards program associated with or otherwise applicable for a customer.

After having identified the rewards and the criteria to be satisfied for providing a reward, the relationship rewards system can begin processing the rewards rules and analyzing the criteria to determine whether the required criteria are satisfied. FIG. 4 illustrates a flow diagram of an example method for analyzing the criteria associated with a rewards rule, according to one example embodiment. This method 400 provides a more detailed example of the operations described with reference to block 215 of FIG. 2. According to one embodiment, the method 400 may be performed by the relationship rewards system, such as the relationship rewards system 105, which may access a host module 178 and/or a relationship rewards module 180, the relationship rewards database 170, and one or more of the data sources 110a-110n, such as those described with reference to FIG. 1. It is appreciated that many variations of FIG. 4 are available in accordance with various example embodiments.

The method 400 may begin at block 405, in which the relationship rewards system begins analysis the criteria associated with a rewards rule set to be analyzed, such as is retrieved as described with reference to FIG. 3. According to some embodiments, multiple criteria may be analyzed before a customer (or account) is determined to be eligible for receiving the corresponding reward or rewards. Though, in other embodiments, only a single criterion may be provided for analysis.

According to one embodiment, the criteria can include at least two individual criterion, and each of the two (or more) criterion can be based on information associated with or derived from different accounts. A first criterion can be based on a first account and a second criterion can be based on a second account that is different from the first account. As stated, the accounts may be associated with the financial institution sponsoring the rewards program, or may be associated with an external system that is not affiliated or otherwise associated with the financial institution. The criterion may be the same or similar type of criterion for each account, with the primary difference being the different accounts analyzed. For example, each criterion may be based on similar account transaction, type, or status information related to each account. As one illustrative example, the criteria may include a requirement that the customer has two different accounts having a certain account type or satisfies at least two types selected from a list of account types (e.g., two checking accounts, a demand deposit account and a checking account, a demand deposit account and an investment account, etc.). As another illustrative example, the criteria may include a requirement that the customer has at least two different accounts having a certain status (e.g., two accounts meeting or exceeding a predetermined minimum balance, two accounts meeting or exceeding a certain activity level within a predetermined period of time, etc.). As another illustrative example, the criteria can include a requirement that the customer has two different accounts that meet or exceed certain transaction type and/or volume requirements (e.g., two accounts each having at least a predetermined number of transactions, such as deposits, transfers, etc., or two accounts each having transactions that individually or cumulatively meet or exceed dollar value or monetary threshold minimum, etc.). In other embodiments, the criterion for each account may be based on different criteria types, such as any combination of the above or below examples or other criteria based or otherwise derived from information associated with each account.

According to another embodiment, the criteria can include at least two different criteria, in which one criterion may be based on information associated with or derived from an account while the other criterion may be based on general customer information. The customer-related criterion may be based on any customer information, such as, but not limited to, customer demographic information, which may generally include, but is not limited to, a customer's age, address, occupation, memberships, etc.; customer status information, which may generally include, but is not limited to, a customer's milestones with the financial institution (e.g., anniversary, etc.) or a customer's status (e.g., silver/gold/platinum, individual/corporate, preferred, etc.); customer preferences, such as those explicitly identified by the customer or those determined based on a customer's activities; or any other information which may generally be utilized to describe or characterize a customer and/or a customer's interactions with the financial institution.

In addition, customer information may further include customer analytics data that is generated based on customer interactions and/or customer history with the financial institution (or other customer activity information), such as may be generated based on statistical modeling, predictive modeling, or other data modeling and analysis techniques. Customer analytics data may include, but is not limited to, a credit score or an attrition risk probability or score; a propensity or probability to buy or use a product or service, or any other propensity that may be identified; a derived current customer value; a derived future customer value; a derived total customer value; the share of the customer's business conducted with financial institution; key drivers or activities that appear to influence or have influenced the customer's activities based on an analysis of historical activities; a derived recommendation for a future action to propose or offer to the customer based on an analysis of that customer; and the like. It is appreciated that customer analytics data may be derived or otherwise determined using any number of techniques that can generally be utilized to provide a prediction or indication of a customer's value or to identify behavior or patterns that can advantageously be utilized to generate one or more rewards to further improve the chances of incentivizing future behavior of the customer. In some embodiments, customer analytics data may not be specific to the instant customer being analyzed for the reward, but may include more general customer information, such as information based on a broader group of customers, information for all or a portion of the customers of the financial institution, or another customer segmentation. According to various embodiments, the customer analytics data may be generated by the relationship rewards system, by the financial institution system, or by a third-party service provider.

It is further appreciated that customer-related information, including the more general customer information and/or the customer analytics data, may actually be based on or derived from information associated with one or more accounts of the customer. Therefore, when criteria are described as being based on more than one account, it may be that the criteria are based on information directly related to an account (e.g., transactions, status, activities, types, etc.) or based on more general customer information that is ultimately derived, at least in part, from information associated with one or more accounts (e.g., the previously described customer analytics data, etc.).

According to another embodiment, the criteria may include multiple individual criterion where at least one criterion includes analysis of a customer's use of products, programs, or services offered by a financial institution. As illustrative examples, product, program, or services criteria may include, but are not limited to, use of online bill presentment services, use of online bill payment services, electronic statement delivery, mobile banking, online banking, use of credit monitoring, use of investment services, private banking services, secure storage services (e.g., safety deposit, etc.), currency conversion, traveler's cheeks, and the like. Thus, product, program, or services criteria may be analyzed to identify other customer activity that is not directly associated with a financial account (although, some of these services may be tied to, funded from, or otherwise associated with a financial account). Notwithstanding, when describing criteria that are based at least in part on an account, the account can be used to generally refer to a customer's use or association with one or more of these or other products, programs, or services, and is not intended to be limited to a financial account.

According to yet other embodiments, the criteria can include multiple criteria associated with the same account, which allows defining multiple criteria to be satisfied in order for a reward to be generated, even if all criteria are associated with the same account.

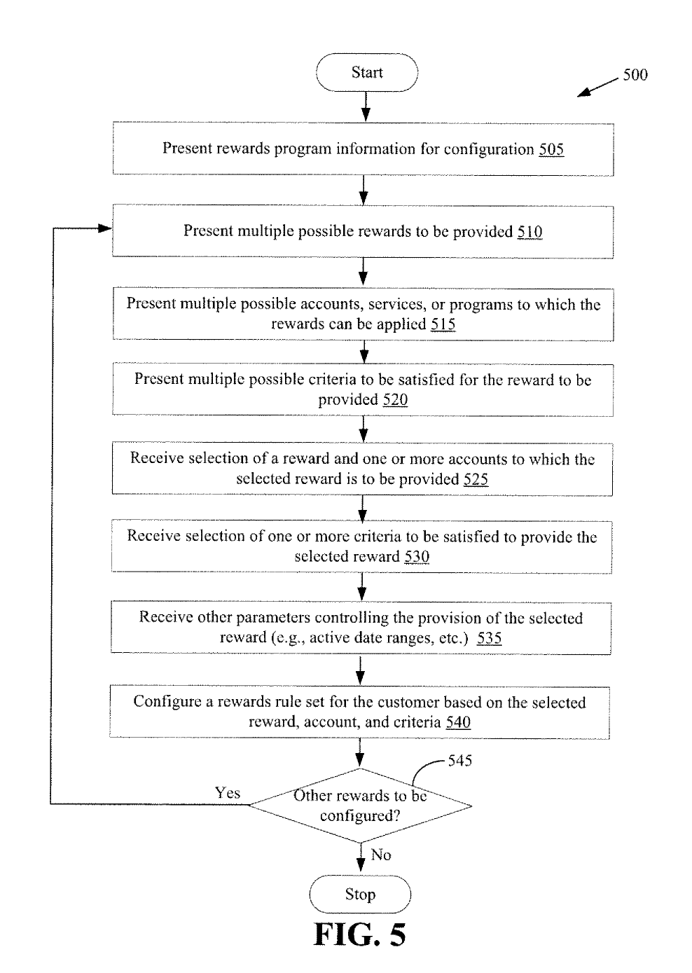

In some embodiments, the criteria associated with a reward may include a number of criteria for which only a subset is to be satisfied to provide the reward. The specific subset or subsets may be explicitly defined, such that each criteria explicitly defined in the subset of criteria is required to be satisfied to generate the corresponding reward. In other embodiments, however, each required subset of criteria may not be explicitly defined, but instead a predetermined number of the total possible criteria may be required to be satisfied without requiring specific criteria. For example, embodiments that include multiple possible criteria may define a minimum number of the total criteria that are to be satisfied before the reward can be provided. In one embodiment, the subset of criteria (or any other criteria described herein) are to be satisfied within a certain time period (e.g., within the last month, within the last ninety days, within the last six months, within the last year, etc.), which may be defined as desired. Thus, a customer may only be eligible for a reward if the subset of criteria are satisfied within the defined time period. Additionally, in some embodiments, rewards may be tiered such that if a certain subset or number of criteria are satisfied, a first reward is provided, and if a different subset or a different number (e.g., an increased number) of criteria are satisfied, a second reward is provided. In some embodiments, a reward may be provided for each subset of criteria satisfied if multiple sets are satisfied. Though, in other embodiments, the reward earning may be cumulative such that only one reward is provided when multiple subsets of criteria are satisfied. As described below, in some embodiments, the relationship rewards system may optionally determine which reward would inure the greatest benefit (or any other deciding factor) and provide that reward when a customer satisfies multiple subsets. Any number of tiers and combinations of criteria can be defined, according to various embodiments. Moreover, analyzing a subset of multiple criteria may also advantageously allow for a more customized configuration of the rewards criteria, such as by a customer or by the financial institution, as described in more detail with reference to FIG. 5.

With continued reference to FIG. 4, following block 405 is block 410, in which the first criterion is selected for evaluation. After block 410 is block 415, in which the account associated with the first criterion is accessed or data associated therewith is otherwise retrieved, such as if stored locally with the relationship rewards system after batch processing. It is appreciated that, according to some embodiments, a criterion may be associated with a single account or account type, such that it can only be satisfied by that account or account type. However, in other embodiments, a criterion may be satisfied by any account or account types, and is not limited to a particular account of the customer's. Thus, in these examples, any account that is capable of satisfying that criteria may be accessed or information otherwise retrieved, and the data associated therewith analyzed, according to the method 400. Moreover, it is appreciated that a single criterion may be associated with multiple accounts.

In other embodiments, a criterion may not be directly associated with any specific account or analyzed based directly on specific account data, but instead may be based on information or data that is derived from account activities. For example, customer analytics data may be derived from account activities without being based directly on specific account data associated with a single account, such as by analyzing past or present customer activities, a portion of which may be associated with the customer's activities specific to one or more accounts, but which may also include other customer activities that are unrelated to specific account data. As discussed above, customer analytics data may include an analysis on past activities and/or predictions of future activities and/or future customer value. Therefore, in some embodiments, information may be derived from data that may take into consideration account-specific activities or other account data, without being directly associated with or tied to a particular account or account type. Accordingly, as used herein, the term “information derived from an account” may include data specifically associated with and/or based on account activities, transactions, status, or type data, as well as data that can more generally include a number of activities with only a portion being generated from or otherwise based on activities associated with one or more particular accounts of the customer.

According to some embodiments, account information may be accessed from one or more financial institution systems where the customer maintains one or more accounts, such as a financial institution system 106 and corresponding financial institution computers 140 described with reference to FIG. 1. Thus, in an embodiment in which the relationship rewards system is operated by a service provider (e.g., a hosted implementation, etc.), then the relationship rewards system may access or otherwise retrieve the data from the financial institution system or systems over one or more networks.

The data may be received as a result of batch processing, which may be associated with periodic files transmitted by the financial institutions periodically, and stored locally within the relationship rewards system, for subsequent processing (e.g., daily, nightly, multiple times a day, etc.) by the service provider. In some embodiments, the batch processing may be initiated by a service provider system, which may be associated with the same service provider operating the relationship rewards system or a different service provider. According to various embodiments, the rewards program processing may be triggered as part of receiving these batch files or at some subsequent time after first storing the batch files upon initial receipt. In other embodiments, the account information may be received in a real-time or near real-time manner, such as in response to an inquiry by the relationship rewards system during rewards processing or if provided as a component of real-time or near real-time transaction updates by the financial institution system.

In an embodiment in which the rewards program is operated by a financial institution, the financial institution systems may have more immediate or direct access to the account information; though, in some embodiments, a batch or periodic process may still be performed internally within the financial institution systems. It is appreciated that, in some embodiments in which a financial institution system is operating the rewards program, the financial institution may receive account data from other external systems, which may include, but are not limited to, other financial institution systems, one or more service providers, external rewards programs, reporting entities, and the like. Moreover, as previously described, in some embodiments, accounts or account information may not be accessed directly, but instead information derived from account information may be utilized when analyzing the criterion.

Following block 415 is block 420, in which any additional (or alternative) data can be accessed for analyzing the criterion. These additional data sources may include data other than specific account data, such as, but not limited to, customer data (e.g., customer demographic information, customer preferences, etc.), other financial institution product, program, or service data (e.g., electronic bill presentment and/or payment data, mobile banking data, customer service data, etc.), customer analytics data (e.g., an analysis on one or more customer's past activities, past value, a prediction of future activities, a prediction on future value, trends, etc.), rewards program data (e.g., rewards history associated with an account, a customer, or generally depicting rewards program activities, customer preferences, configurable thresholds, etc.), or other external data (e.g., external rewards programs, etc.). It is appreciated that the aforementioned sources and types of additional data are provided for illustrative purposes and are not intended to limit the available types of data to be analyzed, according to various embodiments of the invention.

With specific reference to FIG. 1, any one or more of the data sources 110a-110n can be accessed and data retrieved therefrom, or data from one or more of the data sources 110a-110n may have been previously stored in local memory, which can be retrieved directly by the relationship rewards system. For example, account-related data may be retrieved (ultimately) from one or more core account databases 110a and/or one or more non-core account databases 110b. Additional data may be retrieved from one or more other financial institution product, program, or service data sources, such as a bill presentment and payment database 110c, for example, or from one or more customer analytics databases 110d, for example. As mentioned, any other additional data sources 110n may be accessed or data otherwise retrieved therefrom, according to various embodiments. Example content of these data sources 110a-110n is provided in more detail with reference to FIG. 1. It is appreciated that any one or more of these data sources 110a-110n may be maintained remote from the relationship rewards system, such as maintained by one or more financial institution systems, or other systems, or may be maintained internal to the relationship rewards system, or a combination thereof.

Following block 420 is decision block 425, in which it is determined whether the criterion retrieved at block 410 is satisfied according to the accessed data. As described herein, each criterion provided may be based on any of a number of possible data elements, which may include, but are not limited to, the data described with reference to the data sources 110a-110n of FIG. 1. According to some embodiments, a criterion may indicate one or more thresholds, volumes, minimums, maximums, types, statuses, and the like, which are to be satisfied by the relevant data.

If, after analyzing the corresponding data indicated by the criterion, it is determined at decision block 425 that the criterion is not satisfied, then block 430 follows in which it is indicated that at least one of the required criteria are not satisfied, and no reward is to be provided. At this point, operations would cease, at least for the analyzed rewards rule set or reward, such as is indicated after decision block 220 of FIG. 2. However, if the first criterion is satisfied, then operations continue to decision block 435 to determine whether there are any additional criteria to be analyzed for the rewards rule and the reward to be provided. If there are additional criteria to be analyzed, then operations repeat blocks 410-425 to analyze each additional criterion to be analyzed. Accordingly, for rewards that require more than one criterion, the method 400 will perform the operations of blocks 410-425 for each criterion.

Depending upon the configuration of the rewards rules and/or each individual criterion, if at least one criterion is not satisfied, then no reward is to be provided, as indicated at block 430. If all rewards are satisfied, such as is determined at decision block 440, then operations continue to block 445, by which it is indicated that all criteria are satisfied, and the reward or rewards are to be provided. At this point, operations would continue to the method of FIG. 2 after decision block 220 to generate the rewards and corresponding transactions and transmit any indications and/or notifications associated therewith. It is appreciated that, in some embodiments, not all criteria are required to be satisfied in order for the reward or rewards to be provided. For example, multiple possible criteria can be provided, which require only a subset (or possibly multiple subsets) of the criteria to be satisfied to provide the reward or rewards, such as is described in the example with reference to block 315 of FIG. 3. In these embodiments, the determinations at decision blocks 425 and 440 may be altered such that the operations track each criterion satisfied and compare the satisfied criteria to the rewards rule configurations to determine when the required subset and/or number of criteria are satisfied.

In some embodiments, it is possible that a customer may be eligible for more than one reward, such as by satisfying multiple different criteria sets each associated with a different reward. Thus, in one embodiment, the relationship rewards system may optionally provide each of the rewards satisfied. However, in other embodiments, the relationship rewards system may determine which of the multiple rewards is to be provided, such as if a “higher” tier or reward rule set is satisfied in addition to an inclusive “lower” tier or reward set to avoid providing duplicate rewards. For example, according to one embodiment, the relationship rewards system may determine which reward inures the greatest benefit to the customer, thus providing the reward that may most encourage customer loyalty. In another example, the relationship rewards system may determine which reward is most beneficial for the financial institution, such as those having a lesser value (and thus smaller financial impact to the financial institution) or those associated with products or services that the financial institution prefers to market or encourage use. In yet another embodiment, a customer or other user may have previously indicated a preference for one reward over another, such as when configuring the rewards and associated criteria as described with reference to FIG. 5. It is appreciated that, in other embodiments, any number of factors may be utilized to determine which of multiple possible rewards are to be provided, and the aforementioned examples are not intended to be limiting.

Accordingly, the method 400 illustrates example operations for analyzing each criterion associated with a reward to determine whether or not that reward is to be provided. It is appreciated that the method 400 is intended to provide a flexible approach for analyzing any number and combination of criteria associated with a rewards program. The following table (Table I) provides various example criteria combinations that can be provided by a rewards program. These examples are provided for illustrative purposes, and are not intended to be limiting.

TABLE I

| Rewards | | | |
|---|---|---|---|
| Rule Set | Reward | Criterion | Condition |
| 1 | A | POS debit transactions in a | >5 (or other |
| | | first account each month | predetermined volume) |
| | | | AND for each of the past |
| | | | 6 months (or other |
| | | | predetermined period of |
| | | | time) |
| | | Balance in a second account | >$20,000 (or other |
| | | | minimum) AND for each |
| | | | of the past 6 months (or |
| | | | other predetermined |
| | | | period of time) |
| 2 | B | POS debit transactions | >5 (or other |
| | | | predetermined volume) |
| | | Electronic statements | >0 (or other |
| | | | predetermined volume) |
| | | Electronic bill payment | >5 (or other |
| | | transactions | predetermined volume) |
| | | Total deposits (e.g., across | >$2000 (or other |
| | | all accounts or with one or | predetermined minimum) |
| | | more predetermined | |
| | | accounts or account types) | |
| | | [All of the above] | Within past 30 days |
| 3 | C | # of different accounts | = 2 |
| | | established | |
| | D (incrementally | # of different accounts | = 3 |
| | greater value than C) | established | |
| | E (incrementally | # of different accounts | >3 |
| | greater value than C | established | |
| | and D) | | |
| 4 | F | At least X of N criteria | Where X = 5 |
| | | satisfied | |
| | G (incrementally | At least Y of N criteria | Where Y = 10 |
| | greater value than F) | satisfied | |
| | H (incrementally | At least Z of N criteria | Where Z = 15 |
| | greater value than F | satisfied | |
| | and G) | | |
| 5 | I | Electronic statements | >0 (or other |
| | | | predetermined volume) |
| | | | AND within past 30 days |
| | | Customer value score | >X (predetermined score |
| | | | range based on customer |
| | | | analytics data) |
| | J (incrementally greater | Electronic statements | >0 (or other |
| | value than I) | | predetermined volume) |
| | | | AND within past 30 days |
| | | Customer value score | >Y (predetermined score |
| | | | range based on customer |
| | | | analytics data, where Y > |
| | | | X) |
| 6 | K | At least 2 different accounts | |
| | | established | |
| | | Customer attrition value | >X (predetermined score |
| | | score | range based on customer |
| | | | analytics data) |
| 7 | L | Total account balance (e.g., | >$20,000 (or other |
| | | across all accounts or with | predetermined minimum) |
| | | one or more predetermined | AND for each of the past |
| | | accounts or account types) | 6 months (or other |
| | | | predetermined period of |
| | | | time) |
| | | Customer age | 18 >= age <= 30 |
| | M (different reward | Total account balance (e.g., | >$20,000 (or other |
| | than L) | across all accounts or with | predetermined minimum) |
| | | one or more predetermined | AND for each of the past |
| | | accounts or account types) | 6 months (or other |
| | | | predetermined period of |
| | | | time) |
| | | Customer age | >65 |

The Table I indicates seven different example rewards rule sets for generating one or more rewards depending upon the satisfaction of one or more criteria associated with each reward to be provided. For example, rewards rule set “1” provides multiple different criteria, each criterion based on account specific data associated with a different core account, in order to generate reward “A.”

Rewards rule set “2” allows providing a reward “B” if multiple criteria (in this example more than two are satisfied. According to this embodiment, each criterion can be satisfied based on the same account or on different accounts.

Rewards rule set “3” illustrates that possibility of providing tiered or different rewards depending upon one or more thresholds associated with a certain criteria. For example, if a customer maintains two different accounts with the financial institution, then the reward “C” can be provided. However, if the customer has three different accounts with the financial institution, then reward “D” can be provided, or if the customer has more than three accounts, then reward “E” can be provided. In this example, a single reward, either C, D, or E, can be provided, depending upon the number of accounts maintained by the customer, whereby each reward is incrementally greater in value to the customer. In other embodiments, however, a reward can be provided for each tier, such that a first reward would be generated when two accounts are established, a second reward generated when three accounts are established, and so on, where each reward may be different or serve as an improvement to the previously generated reward if one has already been provided to the customer.

The rewards rule set “4” illustrates the tiered reward implementation, where different rewards are provided depending upon how many of multiple possible rewards are satisfied. In this example, the rewards rule set “4” is configured to not discriminate between which specific criteria are satisfied, just whether a certain threshold number of criteria (e.g., 5, 10, or 15) are satisfied. However, in other embodiments, the rewards rule set could be configured to specifically indicate subsets of criteria and the types of rewards to be generated based on satisfying specific subsets.

Rewards rule set “5” shows how multiple criteria can be configured to consider both account specific data (e.g., transaction, activity, status, type, etc.) and customer data (e.g., customer analytics data). Thus, in this example, if a customer has at least one electronic statement delivered within the prior 30-day period and a customer value score (which can be generated according to any number of customer analytics techniques) greater than a predetermined value, a reward can be generated. This example further illustrates the ability to improve the reward generated if the score is improved (or worsened, in some embodiments).

Rewards rule set “6” similarly indicates customer analytics data that can be considered in combination with account specific data, whereby the reward “K” is to be generated if an attrition value score exceeds a predetermined value (e.g., to allow incentivizing customers that show an increased likelihood of leaving, etc.).

Rewards rule set “7” illustrates yet another example of analyzing a combination of account data (e.g., account balance) and customer data (e.g., general demographic data such as age) to generate different rewards. As shown, the reward “L” will be generated for customers between 18 and 30 years of age and having a balance greater than $20,000 (or any other minimum) while a different reward “M” will be provided for customers greater than 65 years of age. Thus, combining customer demographic criteria with account criteria allows tailoring the rewards generated to different customer types.

The rewards “A” through “M” may be any reward type described herein, such as, but not limited to, the rewards described with reference to block 225 of FIG. 2. Any other reward desired may be provided, according to other embodiments.

As stated, it is appreciated that the aforementioned examples are provided for illustrative purposes only and are not intended to be limiting. Any combination of any of the aforementioned data types and criteria, such as those described in more detail with reference to FIG. 1, can be provided and analyzed by the method 400. Accordingly, the method 400 may end after blocks 430 or 445, having analyzed customer and/or account data with regard to one or more criteria to determine whether a reward or rewards are to be generated for that customer (or for that account).

In addition, according to one embodiment, the relationship rewards system may be configured to provide one or more user interfaces indicating the statuses of any relevant rewards rule sets and corresponding criteria that may be associated with or otherwise pertain to the customer and/or an account of the customer. For example, a customer using online banking interfaces, such as when using a customer device 130 over a network 145 as described with reference to FIG. 1, may be presented with additional data indicating a status or statuses of each criterion to be satisfied in order for a reward to be generated. For example, for each account displayed in an online banking platform, any relevant criteria levels or statuses can also be displayed when viewing information associated with the account. The rewards criteria levels or statuses can be displayed according to a variety of techniques, such as, but not limited to, tracking progress, showing percentages, showing numbers or volumes needed for completion, and the like. The rewards criteria levels or statuses can also, or alternatively, be displayed at the customer level, or in an independent view that is not explicitly linked or otherwise associated with account information. The rewards criteria levels or statuses may be presented upon request from the customer or automatically (e.g., such as upon login or upon navigating to one or more other user interface screens, etc.). In addition, a user interface may indicate rewards that have been applied to reinforce to the customer the past benefits received from the rewards programs. Previously applied rewards may be indicated by a conventional account interface (e.g., account overview, account transaction history, rewards program status or history, etc.), or separately in a new user interface specific to the rewards program. Any or a portion of the status or other rewards information may be presented as a real-time or near real-time presentation, or it may possibly be delayed depending upon the frequency with which the rewards program information is made available for presentation to the customer. Any of these user interface presentations may be provided as an entire window or other primary display, as a portion of another display, or as a pop-up window or other widget that is displayed on top of or separate from a primary user interface display.

FIG. 5 illustrates a flow diagram of an example method for configuring rewards rule sets, including selecting one or more rewards and/or selecting one or more criteria, according to an example embodiment. According to one embodiment, the method 500 may be performed at least in part by the relationship rewards system, such as the relationship rewards system 105, which may access a host module 178 and/or a relationship rewards module 180 and relationship rewards database 170, or any other data sources, such as those described with reference to FIG. 1. In addition, according to various embodiments, the relationship rewards system may be operable to communicate with and receive commands from a remote system, which may be a customer device, a financial institution system, or other system operable to access and communicate with the relationship rewards system, such as the customer device 130, the financial institution system 106 and corresponding financial institution computers 140, and the network 145 described with reference to FIG. 1. Thus, in some embodiments, a customer and/or a financial institution operator can supply configuration instructions to selectively configure the rewards and/or the criteria associated with applicable rewards rule sets. It is appreciated that, according to some embodiments, configuration of the relationship rewards system may instead, or additionally, be performed at least in part by an operator of the relationship rewards system according to the method 500. It is appreciated that many variations of FIG. 5 are available in accordance with various example embodiments.

The method 500 may begin at block 505, in which rewards program information may be presented to a user for configuring the rewards program rules, including optionally selecting from multiple possible rewards to be provided and/or selecting from multiple possible criteria to be satisfied in order to provide the reward or rewards. As stated, the rewards program information may be configured by a customer, by a financial institution operator, by a relationship rewards system operator, or by any other user as desired. Therefore, the rewards program information may be presented over a network to one or more remote computer systems, or may be presented to one or more computer system displays situated local to the relationship rewards system. In one embodiment, the rewards program information can be presented over a public network, such as over the Internet to a web-based user interface display, or over a wireless network to a mobile device display, for configuring the rewards program rules. Though, in other embodiments, the rewards program information can be presented over a private network, such as a private local area network, to a computer system situated local to the relationship rewards system.

Blocks 510-520 describe various possible types of rewards program information that may be presented, according to various embodiments. It is appreciated that the extent and type of rewards program information may vary according to different embodiments, which may depend upon the level of customization allowed for the user. For example, at block 510, information describing or otherwise associated with one or more possible rewards capable of being provided can be presented. The reward information presented may include information associated with any of the reward types described herein, such as those described with reference to block 225 of FIG. 2, or any other reward type that may be made available. The information may include, but is not limited to, amounts, percentages, limits, exclusions, restrictions, expiration dates, instructions for use, terms and conditions, and the like, all of which will depend upon the type of reward and the type of account to which the reward will apply.

At block 515, one or more accounts, services, products, or programs to which a reward or rewards can be applied can be presented. In some embodiments, the account, service, product, or program information may be presented for informational purposes to provide details regarding the account or other service, product, or program to which the reward may apply and/or on which the criteria can be based. In other embodiments, however, a user may select the account, service, product, or program to which the reward may be applied and/or on which the criteria can be based. For example, in one embodiment, a user may select one account from multiple accounts for which the activities (or other aspects) of the selected account will be analyzed to generate a reward, such as is described in more detail with reference to FIG. 4. In another embodiment, a user may select one of the user's accounts to which the reward is to be applied if awarded. It is appreciated that the different accounts, services, products, or programs presented at block 515 may differ, depending upon the configuration of the rewards program. For example, in one embodiment, information is presented for only a subset of a customer's accounts, such as for only those accounts that are eligible for selection by the user or only those accounts to which the rewards program may pertain. It is further appreciated that, in some embodiments, the accounts, services, products, or programs presented at block 515 may be constrained based on a separate selection by the user, such as by constraining the accounts, services, products, or programs presented based on the reward or rewards selected.

At block 520, a list of possible criteria can be presented. In one embodiment, the criteria information may be presented for informational purposes, such as if the user cannot select from different possible criteria. In other embodiments, the criteria may be presented for customizing the subset of criteria required for the reward to be presented. For example, a customer may be permitted to configure the criteria required for each reward to be presented. In some embodiments, the available criteria presented at block 520 may include a combination of selectable criteria and required criteria, such as if the relationship rewards system requires certain criteria and allows selection of others. It is appreciated that the information presented at block 520 may include any of the criteria described herein, such as those described with reference to FIG. 1 and FIG. 4, or any other criteria as desired. By allowing the criteria to be customized by the user, the relationship rewards system may serve to increase customer participation in the relationship rewards system by allowing each customer to select meaningful criteria that are more likely to incentivize or otherwise encourage customer behavior.

At block 525, a selection by a user of one or more rewards and/or one or more accounts to which the selected reward is to be provided can be received by the relationship rewards system. For example, in example embodiments, a user interface may be generated (e.g., based on the rewards and account options presented by blocks 510 and 515) through which a user may select one or more rewards from a list of possible rewards. In some embodiments, a user may not be able to select the reward, but may optionally only be permitted to select the account to which the reward will be applied.

Accordingly, a user interface may be generated to also allow a user to select one or more accounts (or other services, products, or programs) to which the reward is to be applied. For example, upon selecting a reward, the list of available accounts may be presented (e.g., at block 515) to which the reward may be applied. The user may then select an account as desired. It is appreciated that, in some embodiments, the rewards program rules may allow applying a reward to multiple accounts and, thus, the user interface may be configured to allow selecting multiple accounts for association with a single reward and, optionally, selecting a proportion of the reward to be applied to each of the multiple accounts. In other embodiments, each reward is applicable to a single account and, thus, the user may or may not be permitted to select the account. For example, if multiple accounts are possible candidate accounts to which the reward can be applied, then the user interface may allow selecting from the multiple possible accounts. Although, in some instances, it may be that only a single account is available for applying the reward. In embodiments allowing selection of only a single account, the list of possible options may be limited to the single account or the account may be automatically associated and, thus, not selectable by the user.

Following block 525 is block 530, in which selection of one or more criteria associated with a respective reward or rewards may be received by the relationship rewards system. Similar to that described with reference to block 525, in some embodiments a user may be permitted to select one or more of the criteria that are required to be satisfied for a reward to be provided. Therefore, a user interface may be generated that presents multiple possible criteria (such as may be presented at block 520) and allows selection of one or more of the possible criteria by the user. The possible criteria may be dependent upon the reward selected or otherwise being configured and/or upon the account (or product, program, or service) to which the reward may be applied. For example, some criteria may only be applicable to certain account types. As another example, certain rewards may have a limited number of possible criteria that may be available. It is appreciated that the lists of possible criteria for selection by users may differ by implementation, and may be defined by a user of the rewards program and/or by the financial institution sponsoring or otherwise providing the rewards program for the customer. In some examples, one or more criteria can be required by the rewards rules, but the user may also select one or more additional criteria to be satisfied. Moreover, the relationship reward system may, in some embodiments, provide additional constraints on the flexibility allowed for its users, such as rules regarding combinations of rewards, criteria, or accounts, or limits regarding the number of rewards, reward program, the number of accounts, the number of criteria, etc. It is appreciated that these constraints may vary by implementation and may be provided based on the desired goals of the respective programs and limits of the associated financial institutions.

Following block 530 is block 535, in which any additional parameters that may be provided by a user can be received. For example, in some embodiments, parameters that indicate when or how the rewards program and associated rewards rules are to be applied may be provided by the user, such as, but not limited to, active date ranges. As one example, a customer may configure one rewards program and corresponding rewards rules to apply for a first predetermined time (e.g., during one month) and a different rewards program and corresponding rewards rules to apply for a second predetermined time (e.g., during the next month or months). In this example, a customer may configure rewards programs differently for different periods of time. As an illustrative example, a customer who anticipates increased volumes of certain activities (e.g., increased deposit activities, increased balances, etc.) in one time period and increased volumes of different activities (e.g., increased bill payment activity or increased point-of-sale transactions, etc.) during a different time period may configure rewards rule programs to generate reward benefits based on a combination of these criteria occurring over these two time periods. Doing so allows the customer to anticipate certain behavior and customize the rewards programs to generate the greatest benefit to the customer. It is appreciated that any other parameter that may be provided by a user and be utilized to operate a rewards program may be collected at block 535, and that the aforementioned examples are provided for illustrative purposes only and are not intended to limit the embodiments described herein.

At block 540, the relationship rewards system may configure the rewards program rule set based on the selections received at any of blocks 525-535. Configuration may include storing the rewards rule set selections in memory, such as in a relationship rewards database 170 described with reference to FIG. 1 or any other data storage device, for subsequent retrieval and analysis. For example, the configured rewards information may be subsequently retrieved during the methods described with reference to FIGS. 2-3 and analyzed by the method described with reference to FIG. 4.

Following block 540 is decision block 545. If it is determined at decision block 545 that additional rewards may be configured, then the operations repeat back to block 510. Otherwise, the method 500 may end after decision block 545, having presented rewards information, including possible rewards, accounts, and criteria, and having optionally received a user's selection of one or more rewards, one or more accounts (or products, programs, or services) to which a reward is to be applied, and/or one or more criteria that are to be satisfied to generate and provide the reward. As previously stated, it is appreciated that customization by a user is not required, but may optionally be provided for some or all aspects of a rewards rule program. In addition, customization may be provided by a customer for whom (or on whose behalf) the reward or rewards are to be generated, or customization can be provided by another system operator, such as a financial institution operator to configure a rewards program. A financial institution operator may configure a rewards program for broad applicability to multiple customer and/or accounts, or, in some instances, for a particular customer, such as when being performed by a customer service representative on behalf of the customer.

Accordingly, the various embodiments described herein may provide systems and methods for providing customer rewards programs. Each rewards program is configured based on a set of rewards rules that identify the type of reward or rewards to be issued and the criteria to be satisfied. As described in detail herein, the rewards program embodiments allow for generating and issuing rewards on complex customer interactions and/or generating unique rewards to customers. By capturing customer activities that are not simply tied to a single account or a single type of transaction, the rewards program improves the ability of a financial institution to reward customers for more involved relationships with the financial institution. Financial institutions or other entities can reward customers for using multiple accounts or different services or products provided by the financial institution or for engaging in high levels of activity with the financial institution. Moreover, embodiments described herein provide a unique ability to generate a reward that can be applied to an account that may be different from the account or accounts that are analyzed to generate the reward. Doing so expands the number and type of available rewards to be provided by not necessarily tying criteria to accounts or types of accounts to which the reward can be applied. Moreover, optional customer configuration and customization of the rewards rules provide increased opportunity to attract and further incentivize customer activity and continued loyalty to the financial institution. Providing customers with at least some level of control over the criteria required for a reward to be generated, or the type of reward to be provided or to what account the benefit will inure, may serve to further encourage customers to engage with and continue to use the services of the financial institution. It is appreciated that these and many other advantages will become apparent in light of the foregoing description.

The operations described and shown with reference to the above methods may be carried out or performed in any suitable order as desired in various embodiments of the invention. Additionally, in certain embodiments, at least a portion of the operations may be carried out in parallel. Furthermore, in certain embodiments, less than or more than the operations described herein may be performed.

The invention is described above with reference to block and flow diagrams of systems, methods, apparatus, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. A special-purpose computer may be a general-purpose computer that is programmed to perform one or more of the steps discussed herein. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method, comprising:
identifying, by a rewards system including one or more computers, a rewards program associated with a financial institution to reward a customer of the financial institution;
identifying, by the rewards system, at least one rewards rule associated with the rewards program that indicates at least one reward to be provided if a plurality of criteria is satisfied, wherein the plurality of criteria includes: (a) at least one criterion based on information derived from a first account of the customer; and (b) at least one criterion based on information derived from a second account of the customer;
determining, by the rewards system, that the plurality of criteria is satisfied; and
generating a transaction to provide the at least one reward for the customer responsive to determining that the plurality of criteria is satisfied.

2. The method of claim 1, wherein at least one of the at least one criterion associated with the first account or the at least one criterion associated with the second account is based on transaction information associated with the first account or the second account, respectively.

3. The method of claim 1, wherein at least one of the at least one criterion associated with the first account or the at least one criterion associated with the second account is based on at least one account status associated with the first account or the second account, respectively.

4. The method of claim 1, wherein at least one of the at least one criterion associated with the first account or the at least one criterion associated with the second account is based on an account type of the first account or the second account, respectively.

5. The method of claim 1, wherein at least one of the at least one criterion associated with the first account or the at least one criterion associated with the second account is based on electronic bill payment activity, wherein the first account or the second account, respectively, is associated with an electronic bill payment service.

6. The method of claim 1, wherein at least one of the at least one criterion associated with the first account or the at least one criterion associated with the second account is based on activity or status information associated with a product or service provided by the financial institution to the customer, wherein the first account or the second account, respectively, is associated with the product or service.

7. The method of claim 1, wherein the at least one criterion associated with the first account is based on customer analytic results for the customer derived at least in part from information associated with the first account.

8. The method of claim 7, wherein the at least one criterion associated with the second account is based on the customer analytic results for the customer, wherein the customer analytic results are derived at least in part on information associated with the second account.

9. The method of claim 1, wherein at least one of the first account or the second account is associated with the financial institution.

10. The method of claim 1, wherein at least one of the first account or the second account is associated with an entity different from the financial institution.

11. The method of claim 1, wherein the at least one reward includes at least one of: (a) a credit to at least one of the first account or the second account; (b) a credit to at least one account different from the first account and the second account; (c) an adjustment to a rate or fee associated with at least one of the first account or the second account; (d) an adjustment to a rate or fee associated with at least one account different from the first account and the second account; or (e) a discount or offer associated with a product or service provided by the financial institution.

12. The method of claim 1, wherein the at least one reward includes one or more points or credits for use in association with a rewards program.

13. The method of claim 1, wherein generating the transaction to provide the at least one reward for the customer includes providing the at least one reward to a third party on behalf of the customer.

14. The method of claim 1, wherein generating the transaction to provide the at least one reward for the customer includes providing at least two rewards in association with at least two different accounts.

15. The method of claim 1, further comprising transmitting an indication of the at least one reward to at least one of: (a) an account system associated with the financial institution; (b) an external account system not associated with the financial institution; (c) a rewards program associated with the financial institution; (d) a rewards program not associated with the financial institution; or (e) the customer.

16. The method of claim 1, wherein determining that the plurality of criteria is satisfied is based at least in part on information associated with at least one of (a) core account data of the financial institution; (b) non-core account data of the financial institution; (c) customer demographic data for the customer; (d) customer analytic data associated with one or more customers of the financial institution; (e) product or service data associated with products or services provided by the financial institution; or (f) external customer or account data not associated with the financial institution.

17. The method of claim 1, wherein determining that the plurality of criteria is satisfied is based on at least one of: (a) account transaction data associated with at least one of the first account or the second account; (b) product or service data associated with one or more products or services utilized by the customer and offered by the financial institution; (c) customer demographic data of the customer; or (d) customer analytic data associated with the customer.

18. The method of claim 1, wherein at least one of the plurality of criteria is configurable by the customer.

19. The method of claim 1, wherein the at least one reward is configurable by the customer.

20. The method of claim 1, further comprising:
presenting a plurality of possible criteria;
receiving a selection of at least one of the plurality of possible criteria; and
associating the selected at least one of the plurality of possible criteria with the rewards rule, wherein the plurality of criteria to be satisfied for the at least one reward to be provided includes the selected at least one of the plurality of possible criteria with the rewards rule.

21. The method of claim 1, wherein the at least one rewards rule comprises a first rule that indicates a first reward to be provided if a first plurality of criteria is satisfied, and further comprising:
identifying, by the rewards system, a second rewards rule associated with the rewards program that indicates a second reward to be provided if a second plurality of criteria is satisfied;
determining, by the rewards system, that the second plurality of criteria is satisfied; and
determining, by the rewards system, to provide one of the first reward or the second reward for the customer, wherein the transaction generated provides the one of the first reward or the second reward determined to be provided to the customer.

22. The method of claim 21, wherein determining to provide the one of the first reward or the second reward for the customer is based at least in part on determining at least one of: (a) that the one of the first reward or the second reward is more advantageous for the financial institution; or (b) that the one of the first reward or the second reward is more advantageous for the customer.

23. A system, comprising:
at least one memory including computer-executable instructions;
at least one communications interface; and
at least one processor in communication with the at least one communications interface and the at least one memory and configured to execute the computer-executable instructions to:
identify a rewards program associated with a financial institution to reward a customer of the financial institution;
identify at least one rewards rule associated with the rewards program that indicates at least one reward to be provided if a plurality of criteria is satisfied, wherein the plurality of criteria includes: (a) at least one criterion based on information derived from a first account of the customer; and (b) at least one criterion based on information derived from a second account of the customer;
determine that the plurality of criteria is satisfied; and
generate a transaction to provide the at least one reward for the customer responsive to determining that the plurality of criteria is satisfied.
